(19) United States
(12) Patent Application Publication
(10) Pub. No.: US 2026/0236896 A1
(43) Pub. Date: Aug. 13, 2026

(54) System and Method for Backing Up, Monetizing, and Managing Social Media Content

(71) Applicant: Digitalage, Inc., Temecula, CA (US)

(72) Inventors: Peter Michaels, Temecula, CA (US); Awan Nord, Los Angeles, CA (US)

(21) Appl. No.: 19/535,931

(22) Filed: Feb. 10, 2026

Related U.S. Application Data
(60) Provisional application No. 63/756,622, filed on Feb. 10, 2025.

(51) Int. Cl. G06Q 10/40

(52) U.S. Cl. CPC G06Q 10/40

(57) ABSTRACT

The inventive system and method revolutionize the way users and creators interact with social media content by securing its longevity, providing a streamlined revenue-sharing model, and ensuring compliance with intellectual property and data protection laws. This integrated approach addresses critical gaps in content preservation and monetization, offering a novel and comprehensive solution for the ever-changing digital landscape. The method involves preserving and monetizing social media content by providing a platform enabling creators to link social media accounts, enabling fans to select content from said creators for backup, storing said selected content in a secure, distributed storage environment, distributing a portion of a fee paid by the fan to the creator, and enabling subsequent access to said stored content even if the original source becomes unavailable.

### BACKGROUND OF INVENTION

### Field of the Invention

The present invention relates generally to the field of digital content preservation, distribution, and monetization. More specifically, it relates to a system and method that enables creators and fans to back up social media content on a secure and user-friendly platform. This invention further incorporates revenue-sharing mechanisms, compliance measures, and platform-agnostic content storage solutions.

### Description of Related Art

Social media platforms host vast amounts of user-generated content. However, creators and fans often face several challenges:
1. Platform Vulnerability: When a social media platform changes its policies, goes offline, or completely shuts down, valuable content is lost;
2. Ownership and Monetization: Creators struggle to monetize their archived content effectively. Third parties often reproduce content without properly compensating the original creator; and
3. User-Driven Preservation: Fans and followers frequently wish to save or archive their favorite content, but existing solutions are fragmented, manual, or reliant on third-party scraping tools that may violate terms of service.

No existing solution effectively combines secure backup, user-driven archiving, and monetized content sharing in a single, compliant platform.

### SUMMARY OF THE INVENTION

The invention is a system and method for backing up social media content, enabling monetization for creators, and providing preservation options for fans. The solution addresses the ephemeral nature of digital content by offering:
1. Secure Archiving: A reliable, long-term storage system for social media posts, videos, images, and other digital content;
2. Revenue-Sharing Mechanism: Creators receive compensation each time their content is backed up by fans or other users within the system;
3. Compliance and Rights Management: The system respects intellectual property rights, ensuring proper permissions are obtained before backing up content;
4. User-Friendly Access: Fans can search, retrieve, and view backed-up content through a streamlined user interface, even if the original social media platform ceases operation or removes the content; and
5. Robust Privacy and Security: End-to-end encryption and secure data handling protocols protect user data and preserve content integrity.

By offering a platform-agnostic approach, the invention ensures that creators maintain control over their content while allowing fans to support and preserve the digital media they value.

### BRIEF DESCRIPTION OF DRAWINGS

FIG. 1: A block diagram illustrating the overall system architecture of the invention, including user devices, cloud storage, payment processing, and compliance modules.

FIG. 2: A flowchart showing the process of uploading, tagging, and backing up content by both creators and fans.

FIG. 3: A schematic representation of revenue distribution and payment flow between platform, creators, and fans.

### DESCRIPTION OF THE INVENTION

### Overview

The invention provides a comprehensive framework for preserving and monetizing user-generated social media content. The platform operates through a combination of front-end interfaces (web and mobile) and back-end services (cloud storage, payment processing, rights management, compliance checks).

### System Architecture

### 1. User Interface (UI)

Creator Portal: Allows creators to register, connect their social media accounts, and set preferences for content availability, pricing, and backup permissions.
Fan Portal: Allows fans to search and select creator content for backup. Fans can also manage their personal archives, view content, and share or recommend content archives to other users (subject to permissions).

### 2. Backend Services

Content Ingestion Module:
Integrates with APIs from various social media platforms (where allowed) and scrapes or retrieves user-permitted content.
Normalizes content into platform-agnostic formats (e.g., standard video file formats, image formats, and text metadata).

Storage and Archive Module:
Utilizes distributed cloud storage for redundancy.
Implements encryption at rest and in transit to protect content integrity.

Metadata and Tagging:
Automatically extracts metadata (e.g., author info, timestamps, hashtags, location data) and applies user-generated tags for easier discovery.

Compliance and Rights Management:
Verifies that the user backing up the content has the right to do so (e.g., content is publicly available, the creator has opted in, or the user has a license/permission).

Payment Processing and Revenue-Sharing:
Integrates with payment gateways (e.g., PayPal, Stripe, cryptocurrency wallets) to manage microtransactions and payouts.
Automates royalty calculation when fans back up content, distributing a portion to the original creator and another portion to the platform or other stakeholders.

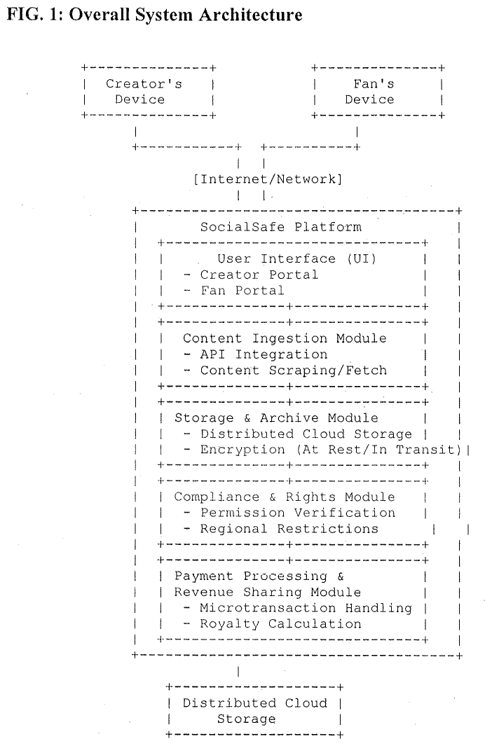

FIG. 1 illustrates how users (both creators and fans) interact with the inventive Platform via their devices over the Internet. The platform comprises several core modules (User Interface, Content Ingestion, Storage & Archive, Compliance & Rights Management, and Payment Processing & Revenue Sharing) that work together with a distributed cloud storage backend.

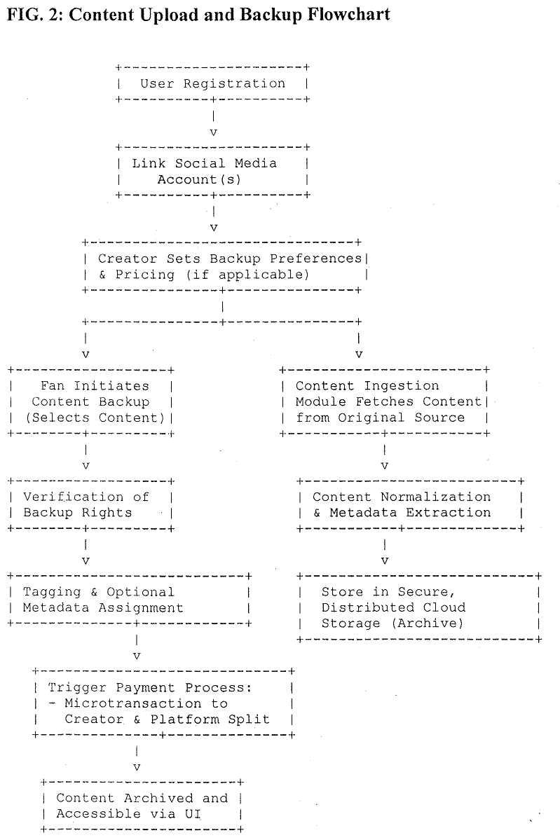

FIG. 2 details the step-by-step process for backing up social media content. It begins with user registration and social media account linking, proceeds through content selection and ingestion (including rights verification and metadata tagging), and culminates in the secure storage of content and automated payment processing for revenue sharing.

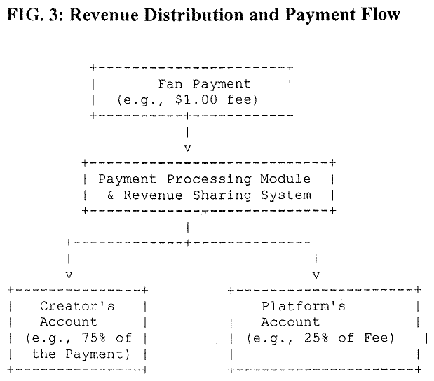

FIG. 3 represents the revenue flow when a fan initiates a backup transaction. The fan's payment is processed by the Payment Processing Module, which automatically splits the fee—allocating a predetermined percentage to the content creator and the remainder to the platform.

### Methods of Operation

### 1. Registration and Onboarding

Creators sign up and link their social media accounts, indicating which content can be backed up, any usage restrictions, and desired pricing tiers or royalty rates.
Fans create an account, verify their identity, and set up a payment method for backing up and viewing content.

### 2. Backing Up Content

When a fan chooses to back up a piece of content (e.g., a tweet, photo, or video), the system checks if the content is eligible for backup (public or with explicit creator permission).
The system fetches the content from the original source, normalizes it, and stores it in a secured, distributed cloud environment.

### 3. Monetization and Revenue Sharing

Each backup transaction triggers a micro-payment. A portion is allocated to the creator's account, and a smaller portion is retained by SocialSafe to cover operational costs.
Creators can withdraw accumulated earnings upon reaching a certain threshold.

### 4. User Access and Viewing

Fans can search and view archived content via the online portal or app, subject to the creator's content settings and any local content restrictions or compliance requirements.
Archived content remains accessible even if the original platform is shut down or the creator's account is suspended on the original platform.

### 5. Compliance and Takedowns

A built-in compliance module monitors for unauthorized uploads or backups.
Creators can request takedowns of content if they believe it is infringing or if they wish to revoke permissions.
Automated checks verify region-specific restrictions (e.g., some content may be banned or restricted in certain jurisdictions).

### EXAMPLE EMBODIMENTS

### Example 1: Musician Content Backup

A musician on Platform A (e.g., YouTube or Instagram) grants the inventive system permission to archive music videos. Fans who enjoy the videos initiate backups. Each backup triggers a micropayment—for example 75% to the musician and 25% to inventive system. If Platform A removes or demonetizes the musician's account, fans still can view the videos through the inventive system's archive, ensuring continued accessibility and revenue.

### Example 2: Educational Videos and Courses

A content creator producing educational videos on Platform B (e.g., TikTok or a specialized course platform) opts to store them on the inventive system. Students who find the material beneficial can back up or subscribe to the archived course material. The creator continues to earn revenue when new backups occur or when archived content is accessed, while ensuring longevity and availability of the educational materials.

### Example 3: Fan Curated “Best Of” Collections

Fans curate themed collections of a creator's best posts. Each curated list is saved in a public or semi-private repository on the inventive system. Other fans can pay a small fee to access or add to the curated list, providing an additional revenue stream to the creator and fostering community engagement.

### ADVANTAGES OF THE INVENTION

1. Long-Term Availability: Content remains accessible even if the original social media platform ceases to operate or removes the content.
2. Monetization: Creators are financially incentivized to participate, turning archiving into a revenue opportunity.
3. Flexible and Scalable: The platform can integrate with various social media APIs and can accommodate diverse file formats and large volumes of data.
4. Enhanced Fan Engagement: Fans actively participate in preserving their favorite content, creating an emotional investment and sense of ownership.
5. Robust Compliance: Built-in systems ensure respect for creator rights and compliance with regional regulations.

1. A method for preserving and monetizing social media content, comprising:
providing a platform that enables creators to link social media accounts;
enabling fans to select content from said creators for backup;
storing said selected content in a secure, distributed storage environment;
distributing a portion of a fee paid by the fan to the creator; and
enabling subsequent access to said stored content even if the original source becomes unavailable.

2. The method of claim 1, wherein the stored content is encrypted, and decryption access is granted only to authorized users with valid credentials or permissions.

3. The method of claim 1, wherein the platform integrates compliance checks that verify content rights and regional restrictions prior to allowing backups.

4. A system for managing and monetizing user-generated social media content, comprising:
a platform with a user interface configured for creators to set availability and fees for backup of their content and link social media accounts;
the platform configured for fans to pay for and initiate backups;
a data storage module configured to encrypt and archive selected social media posts to the platform;
a payment processor configured to distribute micropayments to the creator and to the platform; and
a compliance module configured to ensure legal usage rights and to process takedown requests.
